(19) United States
(12) Patent Application Publication
(10) Pub. No.: US 2015/0020517 A1
(43) Pub. Date: Jan. 22, 2015

(54) HIGH-PRESSURE HOSE VIBRATION SUPPRESSOR

(71) Applicants: Ying Ren, Naperville, IL (US); Artur Alojzy Dudzik, Berwyn, IL (US); Jeffery Alan Wernimont, Naperville, IL (US); Colin William Horn, Algonquin, IL (US)

(72) Inventors: Ying Ren, Naperville, IL (US); Artur Alojzy Dudzik, Berwyn, IL (US); Jeffery Alan Wernimont, Naperville, IL (US); Colin William Horn, Algonquin, IL (US)

(73) Assignee: International Engine Intellectual Property Company ,LLC, Lisle, IL (US)

(21) Appl. No.: 14/377,960

(22) PCT Filed: Feb. 9, 2012
(86) PCT No.: PCT/US12/24458

§ 371 Date: Aug. 11, 2014

(51) Int. Cl. F15B 21/00

(52) U.S. Cl. CPC F15B 21/008
USPC 60/469

(57) ABSTRACT

A vibration suppressor is disclosed that is configured for use in a system having a hose under pulsating hydraulic pressure. The pulsating hydraulic pressure causes vibration of the hose at the pulsation frequency. The vibration suppressor is applied to the hose and is constructed to have a resonant frequency slightly below the pulsation frequency where the pulsating hydraulic pressure is at a peak level, due to, but not limited to, the existence of a resonance in the hydraulic system.

### BACKGROUND

There are a wide variety of machines that employ high-pressure hydraulic systems. Such machines include, for example, tool presses, aircraft systems, and the like. Another such system is a hydraulically actuated, electronically controlled, fuel injection system that is commonly used in diesel engines.

Many of these hydraulic systems require transportation of high-pressure hydraulic fluid between system units. For example, in a diesel engine, hydraulic fluid, such as oil, is transferred between a high-pressure pump and a rail through a hose. The rail, in turn, includes a plurality of outputs through which the fluid is distributed to injectors to assist the injection of fuel into the engine cylinders for combustion.

In a diesel engine, pressure of the hydraulic fluid in the hose is pulsated as it flows between the pump and rail. The pulsation frequency is determined by the operation speed of the pump. The amplitude of this pulsation is exacerbated when the pulsation frequency is close to a resonance of the hydraulic system. As a result, the hose is deformed when it is pressurized. When the pressure is released, the hose typically returns to its original shape. This elastic deformation results in a lateral vibration of the hose. Over time, the vibration can cause fatigue of the hose and/or its connections to the pump and/or rail resulting in a failure of the hydraulic system.

### SUMMARY

Embodiments described herein relate to a high-pressure hose vibration suppressor and associated methods. In one embodiment, a vibration suppressor is configured for use in a system having a hose under pulsating hydraulic pressure at a pulsation frequency. The pulsating hydraulic pressure causes vibration of the hose at the pulsation frequency. The vibration suppressor comprises a suppressor mass and a resilient member configured to extend radially between an exterior surface of the hose and the suppressor mass. The suppressor mass and resilient member form a mechanical system which has a resonant frequency tuned slightly below the frequency where the hose vibrates most significantly, so that suppressor mass will impose a force via the resilient member on the hose to counter the motion of the hose.

Another embodiment provides a method for use in a system having a hose under pulsating hydraulic pressure. The method comprises applying the pulsating hydraulic pressure so as to result in hose vibration at the pulsation frequency, and applying a vibration suppressor about a periphery of the hose. The vibration suppressor has a resonant frequency slightly below the pulsation frequency.

Still another embodiment provides an engine comprising a high-pressure pump providing hydraulic fluid at a pulsation frequency, a distribution rail, and a hose connected to provide hydraulic fluid from the high-pressure pump to the distribution rail. The hose vibrates at the pulsation frequency in response to pulsating pressure induced between the high-pressure pump and the distribution rail. A vibration suppressor is disposed about a periphery of the hose and has a resonant frequency slightly below the pulsation frequency.

### BRIEF DESCRIPTION OF THE DRAWINGS

FIG. 1 illustrates a high-pressure hydraulic system that does not include a vibration suppressor.

FIG. 2 illustrates the high-pressure hydraulic system shown in FIG. 1, where a vibration suppressor has been applied to the hose.

FIG. 3 is a cross-sectional view of the hose and vibration suppressor along lines III-III of FIG. 2.

FIG. 4 is a graph of vibration frequency vs. vibration amplitude in an exemplary hydraulic system without a vibration suppressor.

FIG. 5 is a graph of vibration frequency vs. vibration amplitude in the exemplary hydraulic system referenced in FIG. 4, but with a vibration suppressor.

FIG. 6 shows operations that may be executed to adjust a vibration suppressor to a resonant frequency slightly below the pulsation frequency.

FIG. 7 illustrates selected portions of a high-pressure hydraulic system of a diesel engine, where a vibration suppressor has been applied to a hose.

### DETAILED DESCRIPTION

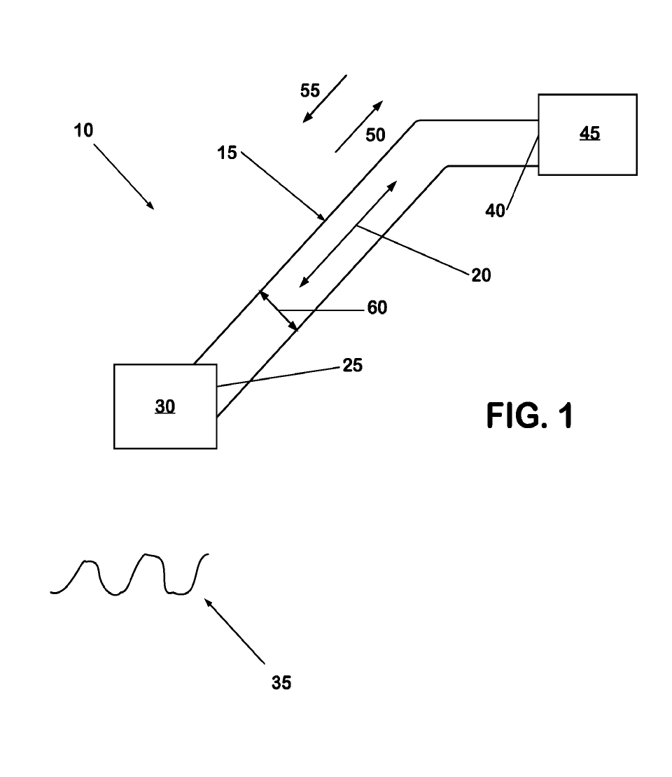

FIG. 1 illustrates a high-pressure hydraulic system that does not include a vibration suppressor. The system 10 includes a hose 15 that carries a fluid 20 under a pulsating pressure, as designated by the end point arrows of fluid 20.

The fluid 20 may be provided at an inlet 25 of the hose 15 from any one of a number of different types of hydraulic supply units 30, such as a high-pressure pump. An exemplary pressure profile of the fluid 20 through hose 15 is shown at 35. Fluid received at the inlet 25 proceeds to an outlet 40 of the hose 15, which may be connected to any of a number of different types of hydraulic system units 45 that are to receive the high-pressure fluid 20. One such system is the rail of a diesel engine.

The hydraulic supply unit 30 pressure rises the hydraulic fluid 20 in the hose 15 at a pulsation frequency as it flows to the hydraulic system unit 45. The hose 15 is deformed so that it is elongated in the direction shown by arrow 50 when it is subject to a positive pressure. When the pressure is released, the hose 15 typically returns to its original shape in the direction shown by arrow 55. As the both ends of the hose are fixed, this elongation motion of the hose often becomes a motion in the lateral direction. It should be noted that this example is directed to a positive pressure system, and that the deformation of the hose 15 would occur in directions opposite to those shown at 50 and 55 in a negative pressure system.

The pulsating pressure through the hose 15 results in a lateral vibration, for example, along a radial axis 60. The lateral vibration occurs at the same pulsation frequency of the fluid provided by the hydraulic supply unit 30. Over time, this vibration can cause fatigue of the hose 15 resulting in failure of the hose material. Further, the vibration may fatigue the connections between the hose 15 and the units 30 and 45 resulting in fluid leakage and/or connection failure.

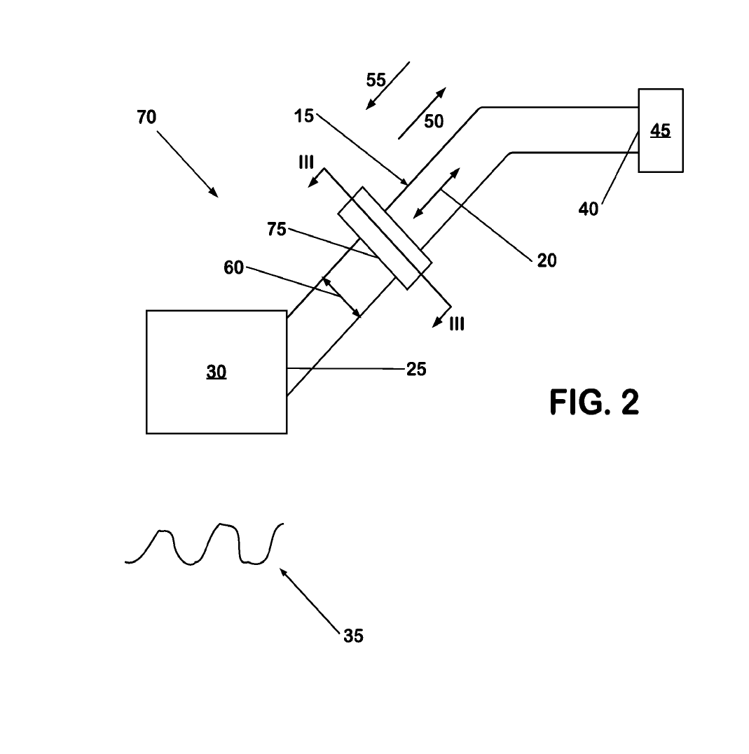

FIG. 2 illustrates a further high-pressure hydraulic system 70 of the type shown in FIG. 1. However, unlike hydraulic system 10, the high-pressure hydraulic system 70 includes a vibration suppressor 75 applied to the hose 15. The vibration suppressor 75 is designed to suppress vibration of the hose 15 in the lateral direction that is caused by the pressure pulsation. Vibration suppression is achieved by designing the vibration suppressor 75 to generate a force that counters the lateral motion of the hose 15. The resonance frequency of the vibration suppressor is adjusted to just slightly below the pulsating frequency so as to maximize the amplitude of the counter force. As a result, the amplitude of the hose vibration is reduced. By reducing the amplitude of the vibration, the reliability and life expectancy of the hose 15 are increased.

Depending on system structure and operational requirements, the vibration suppressor 75 may be applied to the hose in matters other than the one shown in FIG. 2. For example, although a single vibration suppressor 75 is shown, multiple vibration suppressors 75 may be used. Still further, multiple vibration suppressors 75 may be tuned to different resonant frequencies, where each resonant frequency is slightly below the pulsation frequencies where amplitudes of hose vibration are significant.

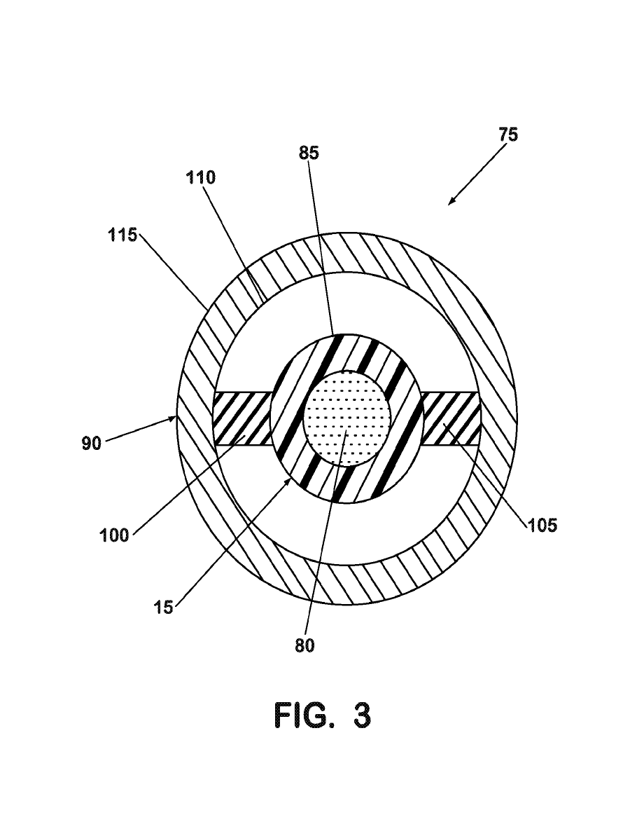

FIG. 3 is a cross-sectional view of the hose 15 and vibration suppressor 75 along lines III-III of FIG. 2. The cross-sectional view illustrates one manner of constructing the vibration suppressor 75 and placing it about hose 15. In FIG. 3, the hose 15 may be flexible and include an interior cavity 80 through which the hydraulic fluid flows at the pulsation frequency and an exterior surface 85 in contact with the vibration suppressor 75.

The vibration suppressor 75 also includes a suppressor mass 90, which may be in the form of a metal sleeve, and one or more resilient members 100 and 105. In FIG. 3, two resilient members 100 and 105 are used. However the two resilient members 100 and 105 may be connected with one another at their end portions. In such instances, resilient members 100 and 105 are in the form of a single resilient member that is divided at a mid-portion of the vibration suppressor 75 to effectively form two resilient members at the mid-portion. Hose and suppressor mass may be molded together via the resilient member to form an integrated hose with a vibration suppressor.

In the embodiment of FIG. 3, each resilient member 100 and 105 may be formed from an elastomeric material, such as rubber or other elastomer. As shown, the resilient members 100 and 105 may be disposed on opposite sides of the hose 15. In this configuration, resilient members 100 and 105 deforms radially between a first portion of the exterior surface 85 of hose 15 and a first portion of the interior surface 110 of the suppressor mass 90.

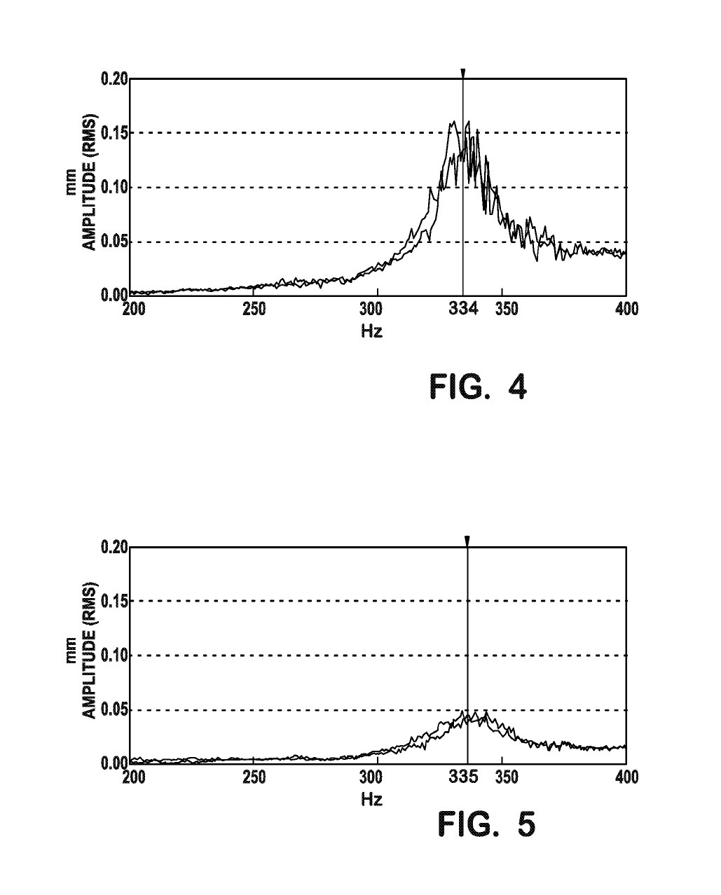

FIG. 4 is an exemplary graph of the amplitude of the vibration of the hose 15 versus frequency. The hose 15 of FIG. 4 does not include a vibration suppressor 75. In this example, the hose 15 experiences a general peak vibration amplitude about the pulsation frequency 335 Hz of approximately 0.15 mm (RMS). The hose does not have a structural resonance at 335 Hz. However, the vibration amplitude of the hose increases around 335 Hz because the amplitude of the pulsating pressure increases which is due to the existence of a 335 Hz resonance in the hydraulic system.

FIG. 5 is an exemplary graph of the amplitude of the vibration of the hose 15 versus frequency when the vibration suppressor 75 is applied to the hose 15. As shown, the hose 15 experiences a general peak vibration amplitude of about 335 Hz. However, when compared to the vibration experience by the hose 75 in FIG. 4, the peak vibration amplitude has been reduced to approximately 0.04 mm (RMS). This amounts to a reduction of the peak vibration amplitude to approximately ⅓ of that experienced by a hose 15 that does not have the vibration suppressor 75 applied. Even though the vibration suppressor 75 helps to reduce the hose vibration, it has almost no effect on the resonance of the hydraulic system (i.e., the pulsating pressure is almost unchanged).

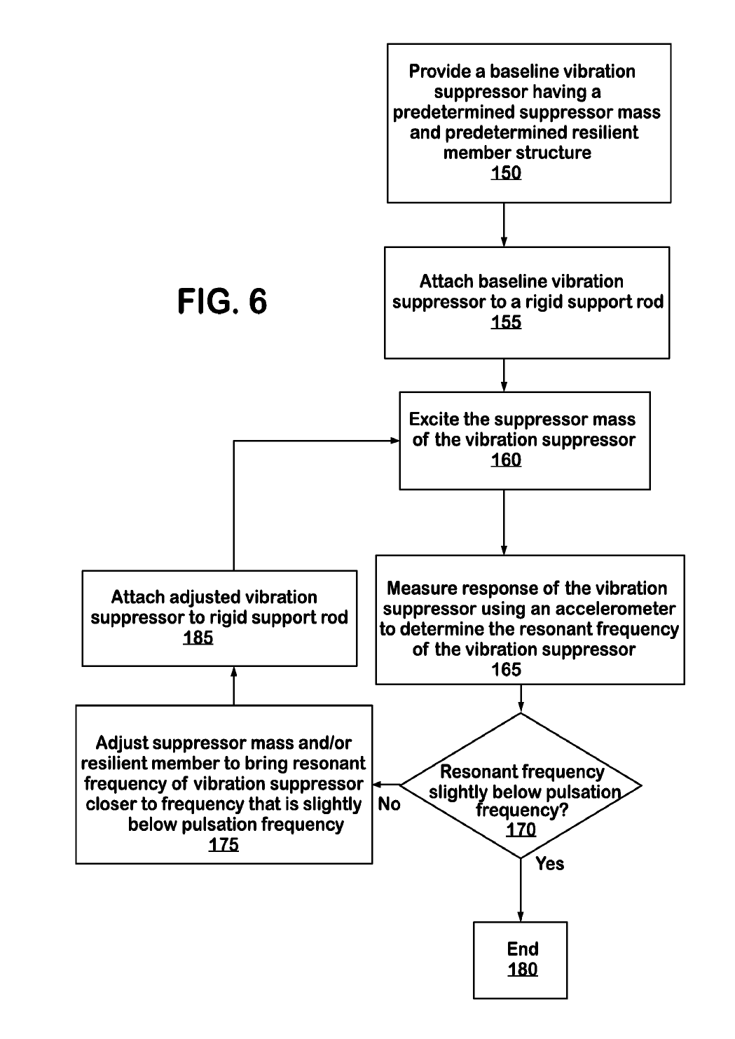

FIG. 6 shows one example of a method that may be used to tune the vibration suppressor 75, such as the one shown in FIG. 3, to a resonant frequency that is slightly below the pulsation frequency. The method may start at operation 150 with a baseline vibration suppressor 75 having a predetermined suppressor mass and predetermined resilient member structure. The baseline vibration suppressor 75 may be attached to a rigid support rod at operation 155. At operation 160, the baseline vibration suppressor 75 is excited. Such excitation may include striking the vibration suppressor 75 with an instrumented hammer. The frequency of the vibration of the vibration suppressor 75 is measured at operation 165 using an accelerometer. A check is made at operation 170 to determine whether the measured resonant frequency is slightly below the pulsation frequency. If it is not, the method may be continued at operation 175 to adjust the resonant frequency to bring it closer to the frequency that is slightly below the pulsation frequency. This may be done by adjusting the characteristics of the resilient member and/or suppressor mass. For example, such an adjustment may include changing the mass of the suppressor mass, changing the elastomeric material of the resilient member(s), changing the dimensions of the resilient member(s), changing the diameter of the suppressor mass opening, and the like. After making the adjustment, the vibration suppressor 75 may be reattached to the rigid support rod, as at operation 185, and the resonance of the suppressor system is re-evaluated beginning again at operation 160. This cycle may be repeated until a satisfactory resonant frequency is obtained, at which point, the method may be ended at 180.

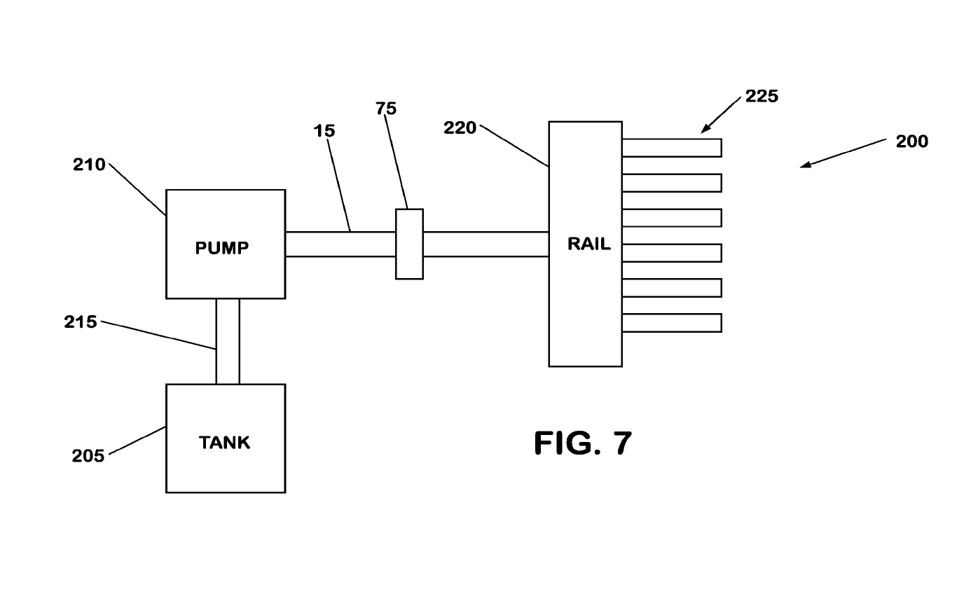

As previously noted, the vibration suppressor 75 may be used in an engine, such as a diesel engine. Such a diesel engine is shown generally at 200 of FIG. 7. The exemplary engine 200 includes a tank 205 that stores a hydraulic fluid, such as oil or fuel. The content of tank 205 is extracted by a high-pressure hydraulic pump 210 through a fluid conduit 215.

The high-pressure hydraulic pump 210 directs the hydraulic fluid to a rail 220 at a pulsation frequency which is determined by the pump rotating speed through hose 15. The hose 15 is provided with a vibration suppressor 75, which reduces the vibration of the hose 15 that would otherwise occur about the pulsation frequency.

The rail 220 provides the hydraulic fluid to a plurality of fuel injectors 225. The pressure of the hydraulic fluid within rail 220 is such that the fluid is distributed to each of the plurality of fluid injectors 225 at substantially the same pressure.

The pulsation frequency is determined by rotating speed of the pump 210. The amplitude of the pressure pulsation is determined by the operating parameters of the pump (i.e., speed of the pump and the desired pressure level) and the response properties of the hydraulic system, which consists of the pump, hose, rail injectors and other components. The pressure pulsation increases dramatically when the pulsation frequency matches a resonance frequency of the hydraulic system. In those instances there are more than one response peaks over the engine operation speed range, multiple vibration suppressors 75 tuned to different resonant frequencies may be employed.

1. A vibration suppressor configured for use in a system having a hose under pulsating hydraulic pressure at a pulsation frequency, wherein the pulsating hydraulic pressure causes vibration of the hose at the pulsation frequency, the vibration suppressor comprising:
a suppressor mass;
a resilient member configured to extend radially between an exterior surface of the hose and the suppressor mass; and
wherein the suppressor mass and resilient member form a mechanical system having a resonant frequency slightly below the pulsation frequency.

2. The vibration suppressor of claim 1, wherein the suppressor mass comprises a metal sleeve.

3. The vibration suppressor of claim 1, wherein the resilient member comprises an elastomer.

4. The vibration suppressor of claim 2, wherein the resilient member comprises a first portion configured to deform radially between a first portion of the exterior surface of the hose and the suppressor mass, and a second portion, opposite the first portion, configured to deform radially between and contact the exterior surface of the hose and the suppressor mass.

5. The vibration suppressor of claim 1, wherein the pulsation frequency differs from a structural resonant frequency of the hose.

6. The vibration suppressor of claim 1, wherein the suppressor mass and the resilient member form a single-degree-of-freedom system to suppress vibration of the hose in a lateral direction.

7. A method for use in a system having a hose under pulsating hydraulic pressure at a pulsation frequency, the method comprising:
applying the pulsating hydraulic pressure resulting in hose vibration at the pulsation frequency; and
applying a vibration suppressor about a periphery of the hose, wherein the vibration suppressor has a resonant frequency slightly below the pulsation frequency.

8. The method of claim 7, wherein the step of applying the vibration suppressor comprises applying a vibration suppressor having a suppressor mass and resilient member configured to form a mechanical system having the resonant frequency slightly below the pulsation frequency.

9. The method of claim 7, wherein the step of applying the pulsating pressure comprises applying the pulsating pressure resulting in a vibration of the hose at a pulsation frequency that is different from a structural resonant frequency of the hose.

10. The method of claim 7, wherein the step of applying the vibration suppressor comprises applying a vibration suppressor to form a single-degree-of-freedom system for suppressing lateral vibration of the hose.

11. An engine comprising:
a high-pressure pump providing hydraulic fluid at a pulsation frequency;
a distribution rail;
a hose connected to provide hydraulic fluid from the high-pressure pump to the distribution rail, wherein the hose vibrates at the pulsation frequency in response to pulsating pressure induced between the high-pressure pump and the distribution rail; and
a vibration suppressor disposed about a periphery of the hose, wherein the vibration suppressor has a resonant frequency slightly below the pulsation frequency.

12. The engine of claim 11, wherein the vibration suppressor comprises:
a suppressor mass; and
a resilient member configured to extend radially between an exterior surface of the hose and the suppressor mass.

13. The engine of claim 11, wherein the pulsation frequency at which the hose vibrates is different from a structural resonant frequency of the hose.

14. The engine of claim 11, wherein the vibration suppressor is formed as a single-degree-of-freedom system.

15. The engine of claim 11, wherein the distribution rail comprises a plurality of outputs configured to provide hydraulic fluid to a plurality of injectors.
